(19) United States
(12) Patent Application Publication
(10) Pub. No.: US 2022/0253648 A1
(43) Pub. Date: Aug. 11, 2022

(54) METHOD, APPARATUS, AND NON-TRANSITORY COMPUTER READABLE MEDIUM FOR AUGMENTING DEFECT SAMPLE DATA

(71) Applicant: HON HAI PRECISION INDUSTRY CO., LTD., New Taipei (TW)

(72) Inventors: JUNG-HAO YANG, New Taipei (TW); CHIN-PIN KUO, New Taipei (TW); CHIH-TE LU, New Taipei (TW); WEI-CHUN WANG, New Taipei (TW)

(21) Appl. No.: 17/573,842

(22) Filed: Jan. 12, 2022

(30) Foreign Application Priority Data
Feb. 9, 2021 (CN) 202110183369.0

(51) Int. Cl. G06K 9/62

(52) U.S. Cl. CPC G06K 9/6257; G06K 9/6215; G06K 9/6267

(57) ABSTRACT

A method for augmenting defect sample data thereof includes acquiring a positive sample image and defect category information of a surface of a product; inputting the positive sample image and the defect category information to a generative adversarial network (GAN); and generating defect sample data corresponding to the defect category information. An apparatus and a non-transitory computer readable medium for augmenting defect sample data are also disclosed.

### CROSS-REFERENCE TO RELATED APPLICATIONS

This application claims priority to Chinese Patent Application No. 202110183369.0 filed on Feb. 9, 2021, the contents of which are incorporated by reference herein.

### FIELD

The subject matter herein generally relates to quality control, to sample surface defects detection technology field, and particularly to a method, an apparatus, and a non-transitory computer readable medium for augmenting defect sample data.

### BACKGROUND

Detecting surface defects is an important process during precision manufacture of components. Surface defects detection usually includes detection of flatness, defects detection, detection of frame uniformity, and detection of surface brightness. A large amount of defect sample data is needed for the surface defect detections. However, it is difficult to collect large amount of defect sample data and establish a sorted and balanced defect sample data.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a flowchart of at least one embodiment of a method of augmenting defect sample data of the present disclosure.

FIG. 2 shows at least one embodiment of a schematic structural diagram of a generative adversarial network of the present disclosure.

FIG. 3 is a flowchart of at least one embodiment of a method of training the generative adversarial network.

FIG. 4 shows at least one embodiment of a schematic structural diagram of an apparatus of the present disclosure.

### DETAILED DESCRIPTION

In order to provide a clear understanding of the objects, features, and advantages of the present disclosure, the same are given with reference to the drawings and specific embodiments. It should be noted that non-conflicting embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art as generally understood. The terms used in the present disclosure are for the purposes of describing particular embodiments and are not intended to limit the present disclosure.

The present disclosure, referencing the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

A great amount of defect sample data is needed for detection of surface defects in products, which is not easy for the technology field. Through training a generative adversarial network (GAN) by a small amount of defect sample data, a great amount of defect sample data can be generated. However, an amount of defect sample data in a same category may be randomly generated by the GAN. Once the defect sample data of a same category exceeds an upper limit of a training sample, the extra defect sample data may be invalid, which may cause a waste of a memory resource.

A method, an apparatus, and a non-transitory computer readable medium for augmenting defect sample data are provided in the present disclosure for predetermining defect categories, generating a specific defect category of defect sample data by the GAN, thereby controlling category distribution of defect sample data and generating sorted and balanced quantitative defect sample data.

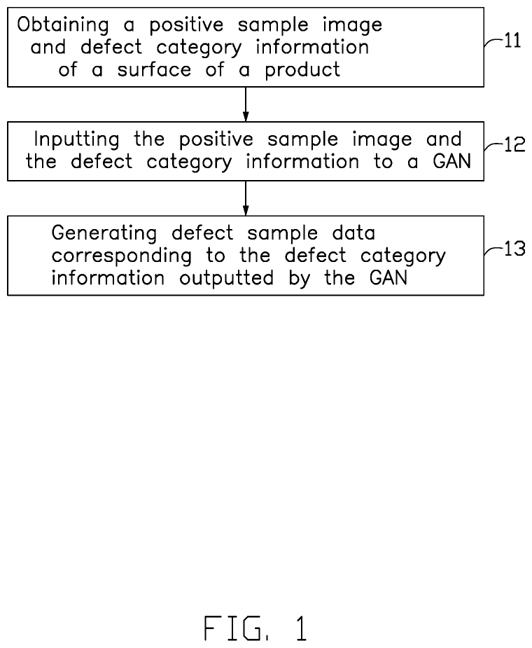

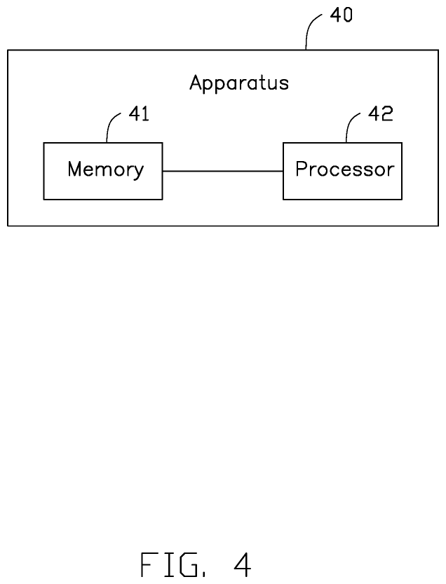

FIG. 1 illustrates a flowchart of at least one embodiment of a method for augmenting defect sample data of the present disclosure. The method is applied to one or more apparatus. The apparatus is a device capable of automatically performing numerical calculation and/or information processing according to an instruction set or having instruction set stored in advance, and the hardware thereof includes but is not limited to a processor, an external storage medium, a memory, or the like. The method is applicable to an apparatus 40 (shown in FIG. 4) for augmenting defect sample data.

In at least one embodiment, the apparatus 40 may be, but is not limited to, a desktop computer, a notebook computer, a cloud server, a smart phone, and the like. The apparatus can interact with the user through a keyboard, a mouse, a remote controller, a touch panel, a gesture recognition device, a voice control device, and the like.

Referring to FIG. 1, the method is provided by way of example, as there are a variety of ways to carry out the method. Each block shown in FIG. 1 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The example method can begin at block 11.

At block 11, obtaining a positive sample image and defect category information of a surface of a product.

In at least one embodiment, capturing positive sample image of a product surface by a charge coupled device (CCD) or a complementary metal oxide semiconductor (CMOS) camera. The positive sample image includes sample image of a detection target. The defect sample image includes sample image of the detection target and random noise.

In at least one embodiment, the defects of product surface may include fluff, fibers, impurities, scratches, bumps, pinholes, etc. In use, the defect category information of the product surface can be obtained by big data analysis.

At block 12, inputting the positive sample image and the defect category information to a GAN.

In at least one embodiment, obtaining a defect category data, such as filaments, impurities, scratches, bruises, pinholes, set by big data analysis. Obtaining a defect category, such as filaments, from the defect category data, inputting the defect category and the position sample image to the GAN, thereby generating defect sample data of a specific defect category.

At block 13, generating defect sample data corresponding to the defect category information outputted by the GAN.

In at least one embodiment, generating defect sample data of predetermined defect category by the GAN, which can control a size of the sample data of the specific defect category, thereby generating defect sample data with multiple categories and sample quantity balancing.

In at least one embodiment, before the block of inputting the positive sample image and the defect category information to the GAN, the method further includes establishing the GAN. The GAN includes a self-encoder and a discriminator.

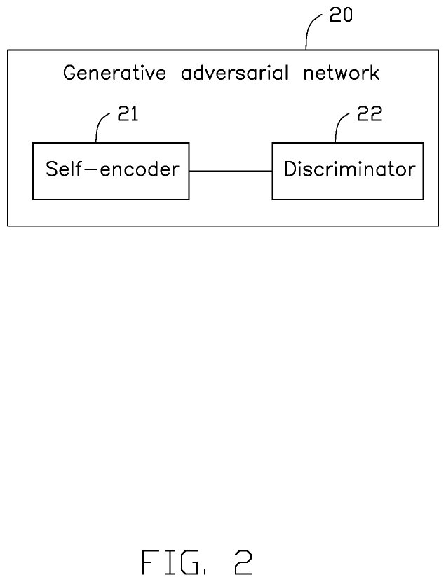

Referring to FIG. 2, in at least one embodiment, the GAN 20 includes a self-encoder 21 and a discriminator 22. The self-encoder 21 is configured to generate the defect sample image according to the inputted positive sample image and the defect category information. The discriminator 22 is configured to determine similarity in the defect sample image generated by the self-encoder 21 and in the real defect sample image inputted to the GAN 20. The similarity means a probability determination of the defect sample image generated by the self-encoder 21 being similar to the real defect sample image, which is in a value range of [0, 1]. For instance, if a similarity value is 0, the discriminator 22 determines that the defect sample image generated by the self-encoder 21 is false, that is, the discriminator 22 determines that the defect sample image generated by the self-encoder 21 is different from the real defect sample image. If a similarity value is 1, the discriminator 22 determines that the defect sample image generated by the self-encoder 21 is true, that is to say, the discriminator 22 determines that the defect sample image generated by the self-encoder 21 is a real defect sample image.

A traditional GAN includes a generator and a discriminator. The generator is configured to generate defect sample image according to inputted random noise. The discriminator is configured to determine a true or false characterization of the defect sample image generated by the generator. In at least one embodiment, the GAN 20 includes the self-encoder 21 for replacing the generator, which can integrate the positive sample image and the defect category information and generate the defect sample image corresponding to the defect category information.

In other embodiments, after the establishing the GAN and before the block of inputting the positive sample image and the defect category information to the GAN, the method further includes training the GAN. In detail, the generating the GAN includes obtaining a training data set and inputting the training data set to the GAN to train the GAN.

The training data set includes a positive sample training image of the product surface, a first defect sample training image, training defect category information, and random noise. The first defect sample training image is marked with a defect category.

In at least one embodiment, the first defect sample training image is the real defect sample image. The training defect category information is a predetermined defect category for training the GAN.

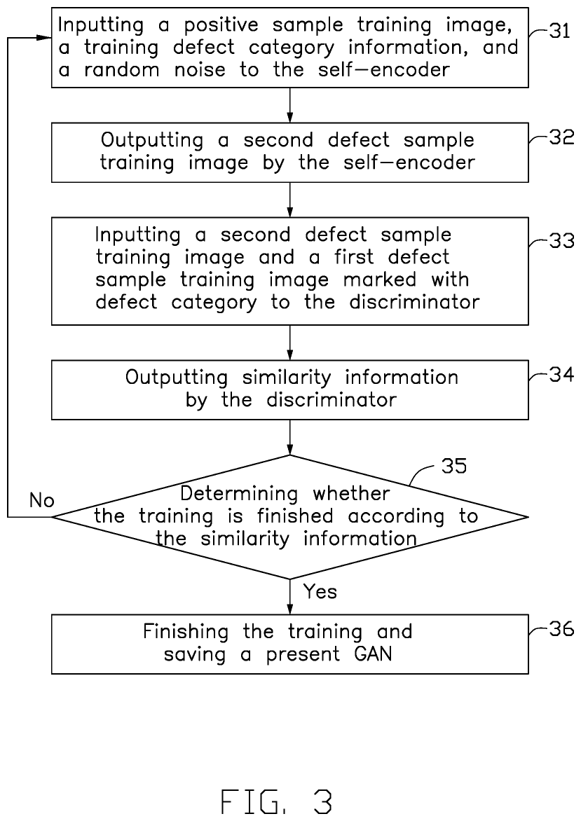

Referring to FIG. 3, in at least one embodiment, training the GAN includes training the self-encoder and training the discriminator, which includes:

At block 31, inputting a positive sample training image, a training defect category information, and a random noise to the self-encoder.

In at least one embodiment, the positive sample training image, the training defect category information, and the random noise constitute the training data set of the self-encoder.

At block 32, outputting a second defect sample training image by the self-encoder.

In at least one embodiment, the second defect sample training image is generated by the self-encoder. The second defect sample training image is a defect sample image corresponding to the training defect category information.

In at least one embodiment, a formula (formula (1)) of a first loss function L_{A} of the self-encoder is: L_{A}=E_{z˜p}_{_{z}}_{(z)}[log(1−D(A(z|d|)))]

Wherein the E means output expectation, the z˜p_{z}(z) means a prior Gaussian distribution of a random Gaussian noise z, the D(A(z|d|)) means a true or false determination of an output of the self-encoder A by the discriminator D in a constraint of a conditional variable d.

In at least one embodiment, the conditional variable d is the training defect category information. A value range of the D(A(z|d|)) is [0,1].

In at least one embodiment, training the self-encoder using the first loss function. The first loss function L_{A} means a probability of the discriminator determining the second defect sample image to be false. The smaller the value of the first loss function L_{A}, the smaller will be the probability of determining as false the second defect sample image by the discriminator viz. the higher will be the quality of the second defect sample image generated by the self-encoder.

At block 33, inputting a second defect sample training image and a first defect sample training image marked with defect category to the discriminator.

In at least one embodiment, the second defect sample training image and the first defect sample training image are the training data set of the discriminator.

At block 34, outputting similarity information by the discriminator.

In at least one embodiment, the discriminator receives the second defect sample training image from the self-encoder and determines a similarity between the second defect sample training image and the inputted first defect sample training image. The similarity information is a similarity value outputted by the discriminator. The similarity value is a probability of the defect sample image generated by the self-encoder being the real defect sample image, which is in a value range of [0, 1].

In at least one embodiment, a formula (formula (2)) of a second loss function L_{D} of the self-encoder is: L_{D}=E_{t˜p}_{_{data}}₍ₜ₎[log D(t)]+E_{z˜p}_{_{z}}_{(z)}[log(1−D(A(z|d|)))].

Wherein the t˜p_{data}(t) means a background distribution of a background target training set t, the D (t) means a true or false determination of a sample in the background target training set t by the discriminator D.

In at least one embodiment, the background target training set t is the first defect sample training image. A value range of the D (t) can be (0, 1).

In at least one embodiment, training the discriminator by a second loss function. The second loss function L_{D} means a probability of the discriminator determining as true the first defect sample training image but determining as false the second defect sample image. The greater the value of the second loss function L_{D}, the greater will be the probability of determining as true the first defect sample training image but determining as false the second defect sample image, viz. the better will be the ability of the discriminator in determining the defect sample image as true or false.

At block 35, determining whether the training is finished according to the similarity information. If the training is determined as finished, a block 36 will be executed. Otherwise, the block 31 will be executed.

In at least one embodiment, the similarity information is configured to determine whether the training of the GAN reaches a predetermined requirement.

In at least one embodiment, operating an iteration training to the self-encoder and the discriminator. The iteration training may include an iteration frequency. After every iteration training, the discriminator generates a similarity value, which can be used to determine whether or not to stop the training. For instance, when a similarity value generated by the discriminator is 0.5, viz. a probability of determining the defect sample image generated by the self-encoder as a real defect sample image by the discriminator is 0.5, the training stops, and a present GAN is saved. In this situation, the discriminator has difficulty determining whether the defect sample image generated by the self-encoder is true or false, viz. a quality of the defect sample image generated by the GAN.

At block 36, finishing the training and saving a present GAN.

In at least one embodiment, a similarity threshold value and a similarity threshold value range can be preset. The similarity threshold value and the similarity threshold value range can be adjusted according to practical usage. When a similarity value generated by the discriminator is equal to the similarity threshold value, or the similarity value is in the similarity threshold value range, the training is finished, and current GAN is saved.

In other embodiments, after finishing the training of the GAN, and before the block 12, the method further includes optimizing the GAN. In detail, the GAN can be optimized by minimax algorithm.

In at least one embodiment, an objective function

$${min}_{A} {max}_{D} V ( D , A )$$

of optimizing the GAN can be read as formula (3):

$${min}_{A} {max}_{D} V ( D , A ) = {E}_{t ∼ {p}_{d a t a} ( t )} [ log D ( t \vert d ) ] + {E}_{z ∼ {p}_{z} ( z )} [ log ( 1 - D ( A ( z \vert d \vert ) ) ) ]$$

Wherein the D (t|d) means that the discriminator D determines the sample in the background target training set t as being true or false in a constraint of a conditional variable d. The target function

$${min}_{A} {max}_{D} V ( D , A )$$

means me probability of determining as true the first defect sample training image and determining as false the second defect sample image by the discriminator D.

In at least one embodiment, the optimizing of the GAN includes optimizing the self-encoder and the discriminator. In detail, when optimizing the self-encoder, remaining the discriminator and minimizing the first loss function of the self-encoder to improve a quality of the defect sample image generated by the self-encoder. When optimizing the discriminator, remaining the self-encoder and maximizing the second loss function of the discriminator to improve the ability of the determinator to determine as true or false the defect sample image generated by the self-encoder.

Optimizing the GAN by the minimax algorithm improves a performance of the GAN to generate defect sample image with high quality.

FIG. 4 shows at least one embodiment of an apparatus 40 including a memory 41 and at least one processor 42. The memory 41 stores instructions in the form of one or more computer-readable programs that can be stored in the non-transitory computer-readable medium (e.g., the storage device of the apparatus), and executed by the at least one processor of the apparatus to implement the method for augmenting defect sample data.

In at least one embodiment, the at least one processor 42 may be a central processing unit (CPU), and may also include other general-purpose processors, digital signal processors (DSPs), application specific integrated circuits (ASICs), and off-the-shelf programmable gate arrays, Field-Programmable Gate Array (FPGA) or other programmable logic device, discrete gate, or transistor logic device, discrete hardware components, etc. The general-purpose processor may be a microprocessor or the processor may be any conventional processor or the like. The at least one processor 42 is control center of the apparatus 40, and connects sections of the entire apparatus 40 with various interfaces and lines.

In at least one embodiment, the memory 41 can be used to store program codes of computer readable programs and various data. The memory 41 can include a read-only memory (ROM), a random access memory (RAM), a programmable read-only memory (PROM), an erasable programmable read only memory (EPROM), a one-time programmable read-only memory (OTPROM), an electronically-erasable programmable read-only memory (EEPROM), a compact disc read-only memory (CD-ROM), or other optical disk storage, magnetic disk storage, magnetic tape storage, or any other storage medium readable by the apparatus 40.

In at least one embodiment, the apparatus 40 may be a computing device such as a desktop computer, a notebook, a palmtop computer, or a cloud server. It should be noted that the apparatus 40 is merely an example, other existing or future electronic products may be included in the scope of the present disclosure, and are included in this reference. Components, such as the apparatus 40, may also include input and output devices, network access devices, buses, and the like.

A non-transitory computer-readable storage medium including program instructions for causing the apparatus to perform the method for augmenting defect sample data is also disclosed.

The present disclosure implements all or part of the processes in the foregoing embodiments, and a computer program may also instruct related hardware. The computer program may be stored in a computer readable storage medium. The steps of the various method embodiments described above may be implemented by a computer program when executed by a processor. Wherein, the computer program comprises computer program code, which may be in the form of source code, product code form, executable file, or some intermediate form. The computer readable medium may include any entity or device capable of carrying the computer program code, a recording medium, a USB flash drive, a removable hard disk, a magnetic disk, an optical disk, a computer memory, a read-only memory (ROM), random access memory (RAM, Random Access Memory), electrical carrier signals, telecommunications signals, and software distribution media. It should be noted that the content contained in the computer readable medium may be increased or decreased according to the requirements of legislation and patent practice in a jurisdiction, for example, in some jurisdictions, computer-readable media does not include electrical carrier signals and telecommunication signals.

The above description only describes embodiments of the present disclosure, and is not intended to limit the present disclosure, various modifications and changes can be made to the present disclosure. Any modifications, equivalent substitutions, improvements, etc. made within the spirit and scope of the present disclosure are intended to be included within the scope of the present disclosure.

What is claimed is:

1. A method of augmenting defect sample data comprising:
acquiring a positive sample image and defect category information of a surface of a product;
inputting the positive sample image and the defect category information to a generative adversarial network (GAN); and
generating defect sample data corresponding to the defect category information.

2. The method according to claim 1, wherein before the inputting the positive sample image and the defect category information to a GAN, the method further comprises:
establishing the GAN;
wherein the GAN comprises a self-encoder and a discriminator.

3. The method according to claim 2, wherein before the inputting the positive sample image and the defect category information to a GAN, the method further comprises:
obtaining a training data set;
wherein the training data set comprises a positive sample training image of the surface of the product, a first defect sample training image, training defect category information, and random noise.

4. The method according to claim 3, wherein training the GAN by the training data set comprises:
obtaining a second defect sample training image by training the self-encoder using the positive sample training image, the training defect category information, and the random noise; and
obtaining similarity information by training the discriminator using the first defect sample training image and the second defect sample training image; and
determining whether finishing the training according to the similarity information.

5. The method according to claim 2, wherein before the inputting the positive sample image and the defect category information to a GAN, the method further comprises:
optimizing the GAN by minimax algorithm.

6. The method according to claim 5, wherein the optimizing the GAN by minimax algorithm comprises:
minimizing a first loss function of the self-encoder; and
maximizing a second loss function of the discriminator.

7. The method according to claim 6, wherein the first loss function is
L_{A}=E_{z˜p}_{_{z}}_{(z)}[log(1−D(A(z|d|)))]
wherein the E means output expectation, the z˜p_{z}(z) means a prior Gaussian distribution of a random Gaussian noise z, the D(A(z|d|)) means a true or false determination of an output of the self-encoder A by the discriminator D in a constraint of a conditional variable d.

8. The method according to claim 7, wherein the second loss function is
L_{D}=E_{t˜P}_{_{data}}₍ₜ₎[log D(t)]+E_{z˜p}_{_{z}}_{(z)}[log(1−D(A(z|d|)))]
wherein the t˜p_{data}(t) means a background distribution of a background target training set t, the D(t) means a true or false determination of a sample in the background target training set t by the discriminator D.

9. An apparatus for augmenting defect sample data comprising:
a memory;
at least one processor; and
the memory storing one or more programs that, when executed by the at least one processor, cause the at least one processor to perform:
acquiring a positive sample image and defect category information of a surface of a product;
inputting the positive sample image and the defect category information to a generative adversarial network (GAN); and
generating defect sample data corresponding to the defect category information.

10. The apparatus according to claim 9, wherein before the inputting the positive sample image and the defect category information to a GAN, cause the apparatus further to perform:
establishing the GAN;
wherein the GAN comprises a self-encoder and a discriminator.

11. The apparatus according to claim 10, wherein before the inputting the positive sample image and the defect category information to a GAN, cause the apparatus further to perform:
obtaining a training data set;
wherein the training data set comprises a positive sample training image of the surface of the product, a first defect sample training image, training defect category information, and random noise.

12. The apparatus according to claim 11, wherein training the GAN by the training data set comprises:
obtaining a second defect sample training image by training the self-encoder using the positive sample training image, the training defect category information, and the random noise; and
obtaining similarity information by training the discriminator using the first defect sample training image and the second defect sample training image; and
determining whether finishing the training according to the similarity information.

13. The apparatus according to claim 10, wherein before the inputting the positive sample image and the defect category information to a GAN, cause the apparatus further to perform:
optimizing the GAN by minimax algorithm.

14. The apparatus according to claim 13, wherein the optimizing the GAN by minimax algorithm comprises:
minimizing a first loss function of the self-encoder; and
maximizing a second loss function of the discriminator.

15. The apparatus according to claim 14, wherein the first loss function is
L_{A}=E_{z-p}_{_{z}}_{(z)}[log(1−D(A(z|d|)))]
wherein the E means output expectation, the z˜p_{z}(z) means a prior Gaussian distribution of a random Gaussian noise z, the D(A(z|d|)) means a true or false determination of an output of the self-encoder A by the discriminator D in a constraint of a conditional variable d.

16. The apparatus according to claim 15, wherein the second loss function is
L_{D}=E_{t˜p}_{_{data}}₍ₜ₎[log D(t)]+E_{z˜p}_{_{z}}_{(z)}[log(1−D(A(z|l|)))]
wherein the t˜p_{data}(t) means a background distribution of a background target training set t, the D (t) means a true or false determination of a sample in the background target training set t by the discriminator D.

17. Anon-transitory storage medium having stored thereon instructions that, when executed by a processor of an apparatus, causes the processor to perform a method for augmenting defect sample data, the method comprising:
acquiring a positive sample image and defect category information of a surface of a product;
inputting the positive sample image and the defect category information to a generative adversarial network (GAN); and
generating defect sample data corresponding to the defect category information.
